(19) United States
(12) Patent Application Publication
(10) Pub. No.: US 2023/0050431 A1
(43) Pub. Date: Feb. 16, 2023

(54) SYSTEMS AND METHODS FOR EARTHQUAKE DETECTION AND ALERTS

(71) Applicant: E.Q. EARTHQUAKE LTD., Ramat Hasharon (IL)

(72) Inventor: Tomer Glaser, Herzliya (IL)

(21) Appl. No.: 17/785,694

(22) PCT Filed: Dec. 16, 2020
(86) PCT No.: PCT/IL2020/051297

§ 371 Date: Jun. 15, 2022

Related U.S. Application Data
(60) Provisional application No. 62/948,851, filed on Dec. 17, 2019.

(51) Int. Cl. G01V 1/00; G01V 1/30; G08B 21/10

(52) U.S. Cl. CPC G01V 1/008; G01V 1/307; G08B 21/10; G01V 2210/1232

(57) ABSTRACT

A method of detecting an earthquake, comprises, by a processor and memory circuitry: obtaining motion data based on data collected by one or more sensors, filtering the motion data to obtain filtered data FD, wherein the filtering comprises, within at least one range of frequencies representative of an earthquake, amplifying one or more frequencies of the motion data within this range, wherein the one or more frequencies are more amplified relative to other frequencies within this range, comparing, at least once, data representative of FD to at least one threshold, if this comparison meets an alerting criteria, generating an alert indicating that an earthquake has been detected.

### REFERENCE TO RELATED APPLICATIONS

Priority is claimed from United States Provisional Patent Application No. 62/948,851 entitled “SYSTEMS AND METHODS FOR EARTHQUAKE DETECTION AND ALERTS” and filed 17 Dec. 2019, the disclosure of which application is hereby incorporated by reference.

### TECHNICAL FIELD

The presently disclosed subject matter relates to methods and systems for earthquake detection and alerts.

### BACKGROUND

Earthquakes can cause various types of damage, such as building damage, and can cause human casualties, or even death.

If an earthquake is detected in advance, this can reduce damage, and even save human lives.

It is therefore a priority, of people and governments, to detect earthquakes, in order to provide appropriate alerts to the population.

On the other hand, false detection of earthquakes can cause unnecessary panic of the population, and also time and money losses.

There is now a need to provide improved methods and systems for detecting earthquakes, in order to alert the population.

### GENERAL DESCRIPTION

In accordance with certain aspects of the presently disclosed subject matter, there is provided a system for detecting an earthquake, comprising a processor and memory circuitry configured to obtain motion data based on data collected by one or more sensors, apply at least one filter on the motion data to obtain filtered data FD, wherein the filter is operative to, within at least one range of frequencies representative of an earthquake, amplify one or more frequencies of the motion data within this range, wherein the one or more frequencies are more amplified relative to other frequencies within this range, compare, at least once, data representative of FD to at least one threshold, and if this comparison meets an alerting criteria, generate an alert indicating that an earthquake has been detected.

In addition to the above features, the method according to this aspect of the presently disclosed subject matter can optionally comprise one or more of features (i) to (v) below, in any technically possible combination or permutation:
i. data representative of filtered data FD comprises at least one value which is higher for motion data representative of an earthquake than for motion data representative of noise;
ii. the range of frequencies representative of an earthquake is comprised in the interval [0 Hz;30 Hz];
iii. at least one range of frequencies representative of an earthquake is [F₁;F_{N}]; wherein the filter is operative to amplify a plurality of frequencies with F₁≤Fᵢ≤F_{N}, wherein the plurality of frequencies Fᵢ are more amplified than other frequencies Fⱼ≠Fᵢ, wherein F₁≤Fⱼ≤F_{N}, wherein there is between at least two different frequencies Fᵢ of the plurality of frequencies Fᵢ at least one frequency Fⱼ;
iv. the filter includes a frequency filter, or at least one filtering function operable to be applied on the motion data for each of a plurality of time instants tₖ to obtain V(tₖ), wherein filtered data FD includes an aggregation of V(tₖ) over the plurality of time instants.
v. the system is configured to, if data representative of FD exceeds a first threshold, trigger a first time window, upon completion of the first time window, compute FD during a second time window and monitor FD during the second time window, wherein if data representative of FD exceeds a second threshold a number of times which is equal to N, generate an alert indicating that an earthquake has been detected, wherein N≥1.

According to another aspect of the presently disclosed subject matter there is provided a system for detecting an earthquake, comprising a processor and memory circuitry configured to obtain motion data based on data collected by one or more sensors, apply at least one filter on the motion data to obtain filtered data FD, wherein the filter includes a filtering function depending on at least one predefined frequency located in a range of frequencies representative of an earthquake, compare data representative of FD to at least one threshold, and if this comparison meets an alerting criteria, generate an alert indicating that an earthquake has been detected.

In addition to the above features, the method according to this aspect of the presently disclosed subject matter can optionally comprise one or more of features (vi) to (xiii) below, in any technically possible combination or permutation:
vi. the at least one filtering function includes a complex function;
vii. the system is configured to apply the at least one filtering function on the motion data for each of a plurality of time instants tₖ to obtain V(tₖ), and aggregating V(tₖ) over the plurality of time instants to obtain filtered data FD, compare a magnitude of FD to at least one threshold, if this comparison meets an alerting criteria, generating an alert indicating that an earthquake has been detected;
viii. a magnitude of V(tₖ) is correlated to the amplitude of the motion data at time tₖ, and a direction of V(tₖ) is correlated to tₖ and to the predefined frequency;
ix. the filter includes at least one decay function configured to attenuate, over time, amplitude of data to which it is applied;
x. the system is configured to, if data representative of FD exceeds a first threshold, trigger a first time window, upon completion of the first time window, compute FD during a second time window and monitoring FD during the second time window, wherein if data representative of FD exceeds a second threshold a number of times which is equal to N, generating an alert indicating that an earthquake has been detected, wherein N≥1;
xi. the filter is configured to amplify frequency components corresponding to the predefined frequency, or to sub-harmonics of the predefined frequency;
   the filter comprises at least one first filtering function depending on at least one first frequency located in a range of frequencies representative of an earthquake, and at least one second filtering function depending on at least one second frequency located in a range of frequencies representative of an earthquake, wherein the first frequency is different from the second frequency.
xii. the system is configured to obtain motion data (M_{X}, M_{Y}) respectively collected along at least two different spatial axes (X, Y), apply at least one filter on at least M_{X}, M_{Y} to obtain respectively filtered data FD_{X}, FD_{Y}, aggregate at least FD_{X}, FD_{Y} into an aggregated representation FD_{X,Y}, compare, at least once, data representative of FD_{X,Y} to at least one threshold, and if this comparison meets an alerting criteria, generate an alert indicating that an earthquake has been detected;
xiii. the system is configured to obtain motion data Mz collected along a third axis Z, different from X and Y, apply at least one filter on M_{z} to obtain filtered data FD_{Z}, weight the aggregated representation FD_{X,Y} based on FD_{Z}, to obtain FD_{X,Y,Z}, compare, at least once, FD_{X,Y,Z} to at least one threshold, if this comparison meets an alerting criteria, generate an alert indicating that an earthquake has been detected

According to another aspect of the presently disclosed subject matter there is provided a method of detecting an earthquake, comprising, by a processor and memory circuitry, obtaining motion data based on data collected by one or more sensors, filtering the motion data to obtain filtered data FD, wherein the filtering comprises, within at least one range of frequencies representative of an earthquake, amplifying one or more frequencies of the motion data within this range, wherein the one or more frequencies are more amplified relative to other frequencies within this range, comparing, at least once, data representative of FD to at least one threshold, if this comparison meets an alerting criteria, generating an alert indicating that an earthquake has been detected.

In addition to the above features, the method according to this aspect of the presently disclosed subject matter can optionally comprise one or more of features (i) to (xiii) above (features expressed above as part of a system can be equivalently expressed as features of a method), in any technically possible combination or permutation.

According to another aspect of the presently disclosed subject matter there is provided a method of detecting an earthquake, comprising, by a processor and memory circuitry, obtaining motion data provided by one or more sensors, based on the motion data, determining filtered data representative of a spectral distribution of the motion data, if data representative of the filtered data exceeds a first threshold, triggering a first time window, upon completion of the first time window, computing filtered data representative of a spectral distribution of the motion data during a second time window, monitoring the filtering data during the second time window, wherein, if data representative of the filtered data exceeds a second threshold a number of times which is equal to N, generating an alert indicating that an earthquake has been detected, wherein N≥1.

According to another aspect of the presently disclosed subject matter there is provided a non-transitory computer readable medium comprising instructions that, when executed by a processor and memory circuitry (PMC), cause the PMC to perform operations in compliance with the various methods described above.

According to some embodiments, the proposed solution is able to detect an earthquake at an early stage, thereby providing early alert to the population.

According to some embodiments, the proposed solution improves the detection of earthquakes, even in the presence of significant environmental noise.

According to some embodiments, the proposed solution improves the detection of earthquakes, even in the presence of noise whose amplitude is higher (at least during an early detection stage) than the amplitude of the earthquake.

According to some embodiments, the proposed solution reduces the probability of false alarms, thereby improving efficiency and trust of the detection.

According to some embodiments, the proposed solution improves accuracy of detection of earthquakes.

According to some embodiments, the proposed solution provides a system for detecting earthquakes which can be installed within a noisy urban environment, where noise sources can be particularly plentiful, intense and unpredictable. According to some embodiments, performance of the system is maintained even in noisy environments.

According to some embodiments, the proposed solution provides a system for detecting earthquakes which does not require calibration.

According to some embodiments, the system can be used in an environment which can include noise sources which do not necessarily all share clear common attributes.

According to some embodiments, since a calibration is not required, various restrictions regarding the installation of the system (e.g. location, height, levelling, type of material for the mounting medium, etc.) do not apply to the system.

According to some embodiments, the system can be installed in environments in which prior art devices would be less or not operational, such as highly populated areas, industrial facilities, etc. in which detection of earthquakes is more beneficial than in remote and quite locations.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates an architecture which can be used to implement one or more methods described hereinafter;

FIG. 2 describes a method of pre-processing motion data received from sensors;

FIG. 3 depicts an embodiment of a method of detecting an earthquake based on the filtering of motion data collected from sensors;

FIG. 4 describe a possible implementation of a method of detecting an earthquake, based on filtering of motion data;

FIGS. 4A and 4B describe examples of transfer functions of a filter used to filter motion data;

FIG. 4C depicts an example of filtered data obtained using the method of FIG. 4, and its comparison to a threshold;

FIG. 4D depicts an embodiment in which the method of FIG. 4 is applied based on motion data collected along a plurality of axes;

FIG. 5 describes another possible implementation of a method of detecting an earthquake, based on filtering of motion data;

FIG. 6 describes an embodiment of the method of FIG. 5;

FIG. 7 describes an example of the method of FIGS. 5 and 6;

FIG. 7A shows a non-limitative example of an effect of the filtering process of FIGS. 5 to 7;

FIG. 7B shows a non-limitative example of a transfer function depicting the effect of the filtering process of FIGS. 5 to 7;

FIG. 7C illustrates a possible example of an output of the method of FIG. 7, for motion data corresponding to an earthquake;

FIG. 7D illustrates a possible example of an output of the method of FIG. 7, for motion data corresponding to noise;

FIG. 8 describes an embodiment of the method of FIGS. 5 to 7, in which the filter comprises at least a first filtering function and a second filtering function;

FIG. 9 describes an embodiment of the method of FIGS. 5 to 7, based on motion data collected along a plurality of axes;

FIG. 9A represents a transformation of the aggregated output obtained in FIG. 9 for a plurality of axes, from a 2D plane to a surface of a sphere;

FIG. 10 depicts an embodiment in which an attenuation function is applied to motion data;

FIG. 11 describes a method of triggering an alert of an earthquake, based on the various methods described above; and

FIG. 12 describes an example of the method of FIG. 11.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods have not been described in detail so as not to obscure the presently disclosed subject matter.

Unless specifically stated otherwise, as apparent from the following discussions, it is appreciated that throughout the specification discussions, utilizing terms such as “obtaining”, “comparing”, “generating”, “applying”, “determining”, “identifying”, “triggering” or the like, refer to the action(s) and/or process(es) of a processing unit that manipulates and/or transforms data into other data, said data represented as physical, such as electronic, quantities and/or said data representing the physical objects.

The term “processing unit” covers any computing unit or electronic unit with data processing circuitry that may perform tasks based on instructions stored in a memory, such as a computer, a server, a chip, a processor, a hardware processor, etc. It encompasses a single processor or multiple processors, which may be located in the same geographical zone or may, at least partially, be located in different zones and may be able to communicate together.

The term “memory” as used herein should be expansively construed to cover any volatile or non-volatile computer memory suitable to the presently disclosed subject matter.

Embodiments of the presently disclosed subject matter are not described with reference to any particular programming language. It will be appreciated that a variety of programming languages may be used to implement the teachings of the presently disclosed subject matter as described herein.

The invention contemplates a computer program being readable by a computer for executing one or more methods of the invention. The invention further contemplates a machine-readable memory tangibly embodying a program of instructions executable by the machine for executing one or more methods of the invention.

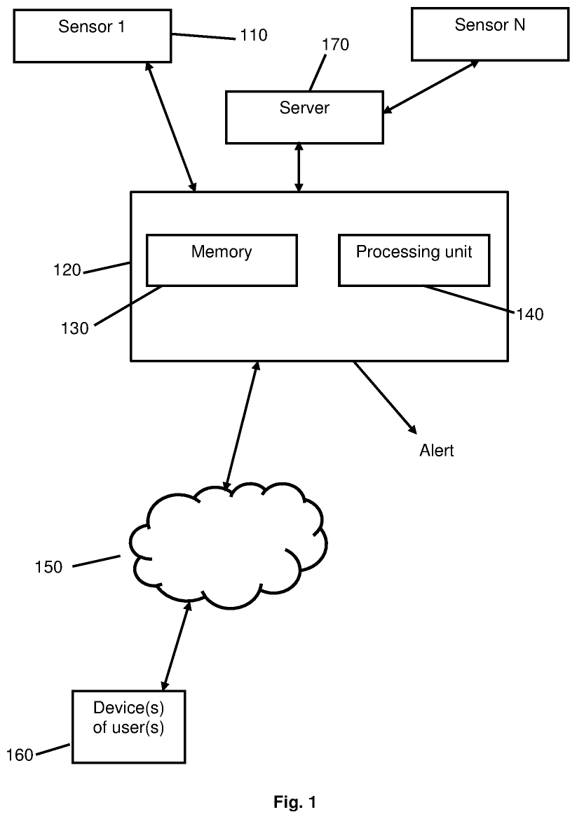

FIG. 1 illustrates an architecture which can be used to implement one or more methods described hereinafter.

As shown, one or more sensors 110 are provided. The sensors 110 can sense motion data, and, in particular, data representative of the motion of the Earth.

The motion data can include e.g. displacement data, velocity data, acceleration data, etc.

Examples of sensors 110 (motions sensors) include e.g. piezoelectric sensors, transducers, LVT sensors, IMS, electromechanical sensors, capacitive sensors, force-balanced sensors, etc.

In some embodiments, one or more of the sensors 110 can provide motion data according to two different axes (X, Y) or three different axes (X, Y, Z).

The sensors 110 can be affixed e.g. to the ground, or to a building, or to another adapted structure (road, bridge, etc.). In some embodiments, one or more sensors 110 can be located in the sea (e.g. on a platform located in the sea, or on the seabed).

An earthquake (also known as a quake, tremor or temblor) is the shaking of the surface of the Earth, resulting from the sudden release of energy in the Earth's lithosphere that creates seismic waves.

As a consequence, when an earthquake occurs, mechanical vibrations can be present in the surface of the Earth and in various structures located on Earth, which can be sensed by sensors 110.

In addition, environmental noise can be present, which can be also sensed by sensors 110. Indeed, mechanical vibrations can be caused by various sources, e.g. vehicle traffic, trains, plane landings, public works, sea drilling operations, shock caused by human activities (sport, displacement, manual hammering, drilling, falling objects, etc.),

As shown in FIG. 1, output of sensors 110 (or data representative of this output) can be provided to a system 120. Generally, output of sensors 110 is a numerical discrete signal.

System 120 can include at least one processor and memory circuitry (see memory 130 and processing unit 140).

Communication between sensors 110 and system 120 can be based e.g. on wire communication, and/or wireless communication. In some embodiments, sensors 110 communicate with a server 170 (which includes e.g. a processor and memory circuitry), and the server 170 communicates data collected by the sensors 110 (or data representative thereof) to the system 120.

In some embodiments, sensors 110 and system 120 are enclosed in a common housing, but this is not mandatory.

As explained hereinafter, system 120 is configured to execute one or more methods of detecting an earthquake based on data (in particular motion data) provided by sensor(s) 110.

System 120 can trigger an alert if an earthquake has been detected.

In some embodiments, system 120 includes an alerting function (which can be implemented e.g. by a processor and memory circuitry), which can comprise e.g. a textual alarm (e.g. an alerting message is displayed), a visual alarm (e.g. a red button can be activated), or an audio alarm (e.g. a siren can be triggered), etc.

In some embodiments, system 120 can communicate with other devices in order to communicate the alert. For example, system 120 can communicate, through a network 150 (e.g. wireless network such as Internet, or wire network including cables) with devices 160 of users (e.g. cellular phones, dedicated alerting devices, computers, distribution systems, etc.) in order to transmit to them an alert when an earthquake has been detected.

In some embodiments, system 120 can include a user interface (e.g. screen with keyboard) which allows an operator (such as a user) to communicate data with the system 120.

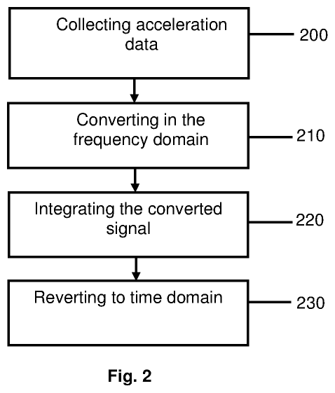

Attention is now drawn to FIG. 2, which describes a method of pre-processing motion data obtained based on data collected by sensors 110. The method can be performed by system 120 or by another processor and memory circuitry in communication with sensors 110.

In some embodiments, if acceleration data is received from sensors 110 (operation 200), and it is desired to process velocity data, the method can include converting the acceleration data into velocity data. This can include e.g. setting a time window on which the integration is to be performed, converting (operation 210) the received signal from time domain to frequency domain (a non-limitative example can include FFT transformation), integrating (operation 220) the converted signal, and reverting (operation 230) to time domain (a non-limitative example can include iFFT transformation).

According to some embodiments, if acceleration data is received, and it is desired to process displacement data, then the operations described above (210, 220, 230) can be applied again to convert velocity data into displacement data. Alternatively, at operation 220, a double integration (instead of a single integration) is performed to convert acceleration data into displacement data.

According to some embodiments, if velocity data is received, and it is desired to process displacement data, then the operations described above (210, 220, 230) can be applied to convert velocity data into displacement data.

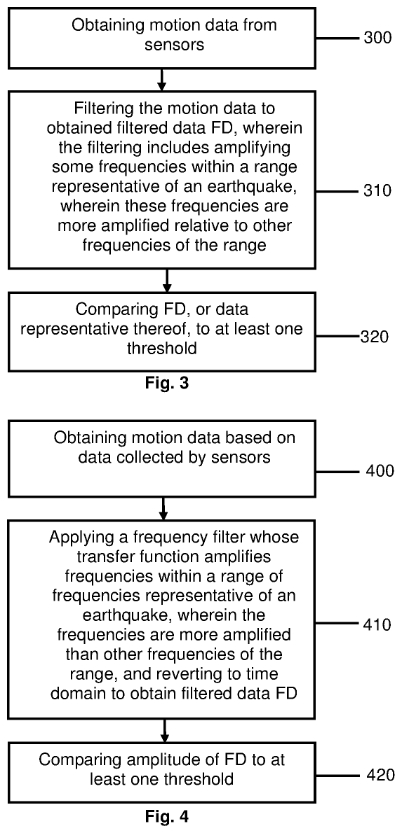

Attention is now drawn to FIG. 3, which can be used to detect an earthquake. The method can be executed e.g. by (at least partially) system 120.

The method can include obtaining (operation 300) motion data, based on data provided e.g. by sensors 110.

The method can comprise filtering the motion data to obtain filtered data FD. The filtering can include applying at least one filter which can be e.g. a digital filter which is implemented by a processor and memory circuitry (such as processing unit 140 and memory 130).

Various embodiments for performing this filtering operation will be described hereinafter.

The filtering operation includes receiving an input signal (motion data) and converting it into an output signal (filtered data FD).

According to some embodiments, the filtering operation includes, within at least one range of frequencies representative of an earthquake, providing more weight to one or more frequencies within this range, relative to other frequencies within this range.

In particular, according to some embodiments, the filtering operation includes, within at least one range of frequencies representative of an earthquake, amplifying one or more frequencies of the motion data within this range, wherein this amplification is higher for these one or more frequencies of the motion data relative to other frequencies of the motion data within this range. The other frequencies can be attenuated, or can be less amplified.

Examples of the range of frequencies representative of an earthquake will be provided hereinafter. The range of frequencies representative of an earthquake in which the filtering operation is performed as explained above can be set e.g. by an operator.

In some embodiments, the amplification can follow a linear evolution (e.g. if a range of frequencies representative of an earthquake is defined as [F₁;F₁₀], then frequencies in range [F₁;F₅] are amplified, and this amplification is higher than for frequencies located in range]F₅;F₁₀], with F₁<F₅<F₁₀).

In other embodiments, the amplification can follow a nonlinear evolution. In particular, some frequencies located within range [F₁;F₁₀] will be more amplified than other frequencies in this range, without necessarily having a clear split between a subset of low frequencies [F₁;F₅] and a subset of high frequencies]F₅;F₁₀]. For example, frequencies within frequency bands [F₁;F₃], [F₄;F₅] will be amplified, whereas frequencies frequency bands [F₃;F₄] and [F₅;F₁₀] will be less amplified or even attenuated (F₁<F₃<F₄<F₅<F₁₀).

More generally, according to some embodiments, if a given range of frequencies representative of an earthquake is defined as [F₁;F_{N}] (this can be selected e.g. by an operator), then a plurality of frequencies Fᵢ, with F₁≤Fᵢ≤F_{N}, will be amplified, whereas all other frequencies Fⱼ≠Fᵢ will be less amplified or even attenuated (F₁≤Fⱼ≤F_{N}), wherein the plurality of frequencies Fᵢ do not constitute a continuous range of frequencies within interval [F₁;F_{N}] (that is to say that between at least two or more different frequencies Fᵢ of the plurality of frequencies Fᵢ, there is at least one value Fⱼ), thereby allowing selective amplification.

In some embodiments, the filtering can include:
performing selective amplification as explained above within a first sub-range located in the range of frequencies representative of an earthquake (the first sub-range corresponds typically to low frequencies of the range); and
for a second sub-range of frequencies located in the range of frequencies representative of an earthquakes (the second sub-range corresponds typically to high frequencies of the range), attenuating or cutting all frequencies of this subset. In some embodiments, the second range of frequencies is more attenuated than all frequencies of the first range.

As mentioned above, it is intended to differentiate between motion data originating from an earthquake, and motion data originating from one or more sources of noise.

Generally, sources of noise produce noise at high frequency (relative to the main/dominant frequency of an earthquake).

In addition, sources of noise (of the type produced by humans) generally produce noise in a frequency band (the frequency band corresponds to the difference between the maximal frequency and minimal frequency of the signal—this frequency band varies across noise sources) which is thin (relative to the frequency band of an earthquake, which is wider and comprises more frequencies). For example, a large number of sources of noise can comprise a spectral distribution which can be modelled or approximated as a pulse.

Some sources of noise can produce noise with a larger frequency band, but in this case, since energy is spread over a larger number of frequencies, amplitude of the noise is generally lower (in particular, relative to an earthquake).

In light of the foregoing, since the filtering operation provides more amplification to some frequencies relative to others within a range of frequencies representative of an earthquake, noise with a thin frequency band will most probably be less amplified than motion data representative of an earthquake (for which the frequency band located in this range is generally wider than noise). In addition, even if the noise has some width in its frequency band, its amplitude is generally lower (because the energy is spread) than an earthquake, and therefore it will most likely be less amplified than motion data originating from an earthquake.

This differentiation effect is even increased for frequencies which are in the low part of the range of frequencies representative of an earthquake, because noise is generally located at a high frequency rather than at a low frequency (relative to a dominant frequency of most earthquakes).

As a consequence, it is expected that the filtering process will provide a filtered output which has a higher amplitude or magnitude for motion data representative of an earthquake, than for motion data representative of noise. This allows better differentiation between noise and motion data representative of an earthquake.

Generally, filtering is performed on a portion of the motion data collected during a time window (e.g. a plurality of time windows). Therefore, filtered data FD can be obtained, wherein FD is representative of the motion data (in particular of its amplitude and spectral distribution) over this time window after the filtering process.

The method can further include (operation 320) comparing (at least once over a certain period of time) filtered data FD (or data representative thereof) to at least one threshold.

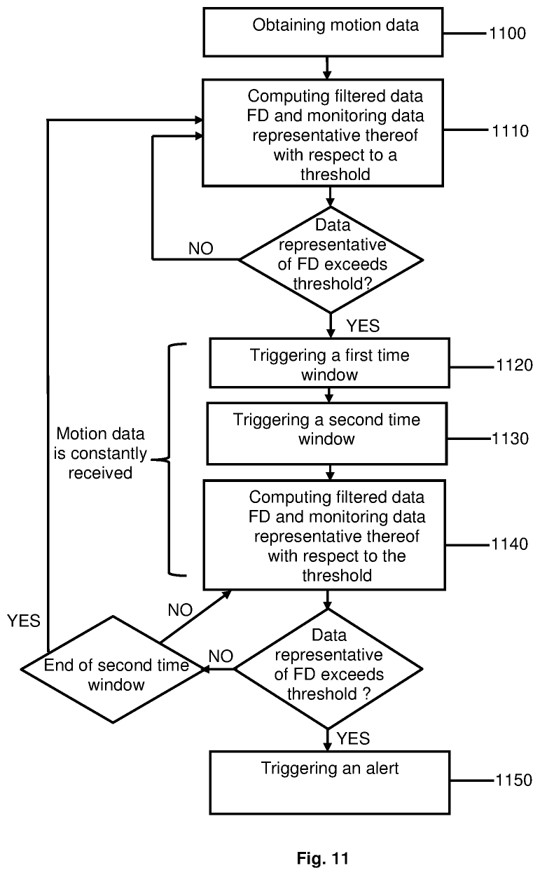

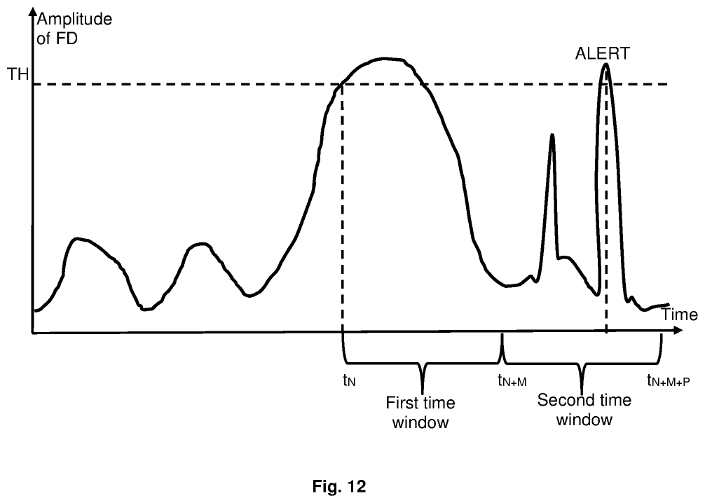

Based at least on this comparison, an alert can be raised indicating that an earthquake has been detected (in some embodiments, an alerting criteria can be set to define when the alert is to be raised, as explained e.g. with reference to FIGS. 11 and 12).

In particular, according to some embodiments, it can be expected that if the motion data collected by the sensors correspond to an earthquake, filtered data FD will be different than filtered data FD that would have been obtained for pure environmental noise.

In particular, as explained above, it can be expected that filtered data FD comprises at least one representative value which is higher for motion data representative of an earthquake, than for motion data representative of noise (which includes noise originating from sources other than an earthquake, thereby constituting noise relative to the earthquake signal).

Therefore, an earthquake can be differentiated from environmental noise, and an alert can be raised accordingly.

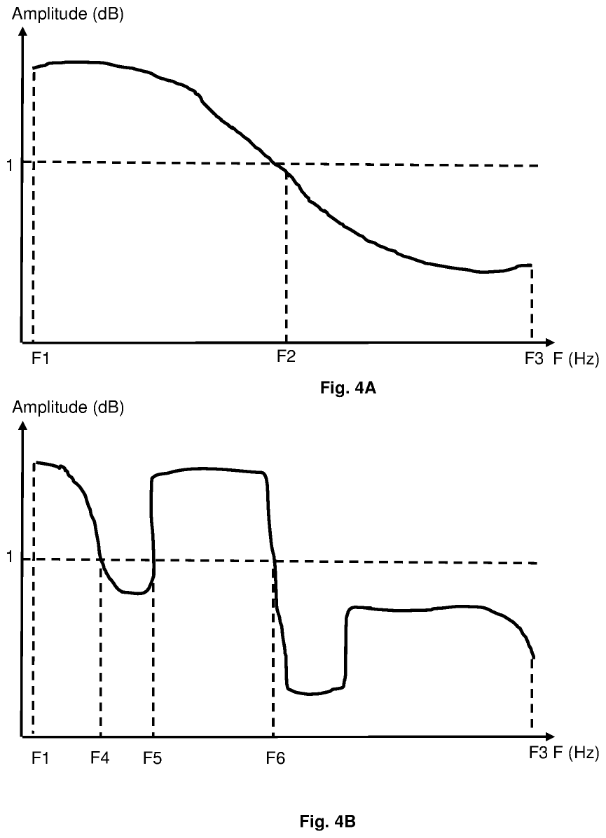

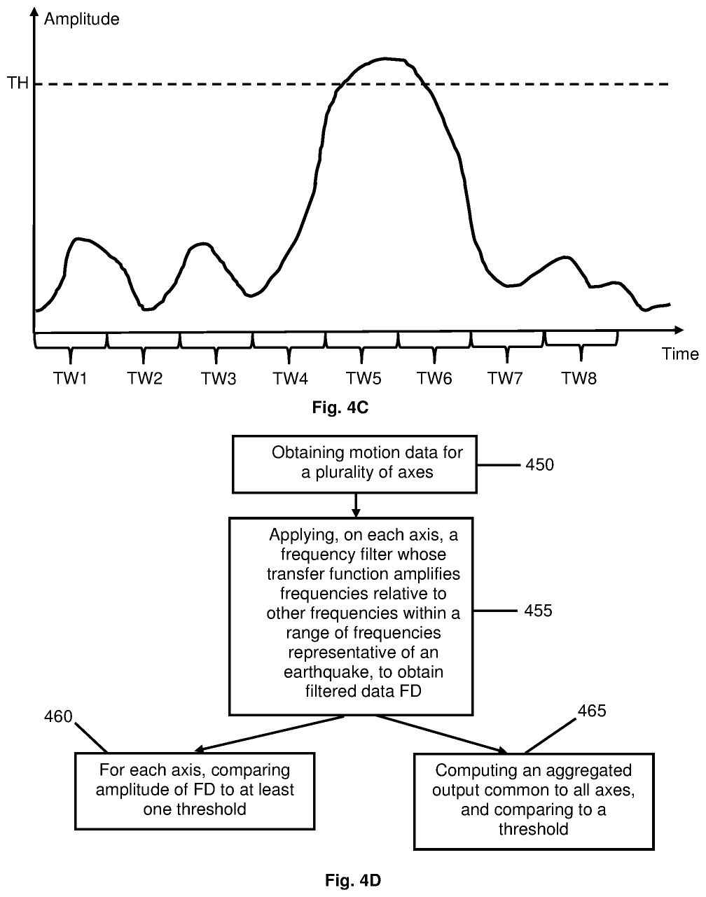

Attention is drawn to FIG. 4, which describe a possible embodiment of a method of detecting an earthquake, in accordance with the method of FIG. 3. The method can be executed e.g. by (at least partially) system 120.

The method comprises obtaining (operation 400) motion data, which can be collected by sensors (110). This operation is similar to operation 300 above.

The signal (motion data) can be processed within a plurality of consecutive time windows. For example, duration of each time window can be pre-set.

Within each time window, the signal can be filtered by a frequency filter. In particular, the frequency filter can have a transfer function which amplifies frequencies within a range of frequencies representative of an earthquake, wherein these frequencies are more amplified relative to other frequencies within this range. In some embodiments, the other frequencies can be attenuated or cancelled. Since a frequency filter is applied in this embodiment, the signal (motion data) of each time window is first converted into a frequency representation before filtering, using e.g. FFT, or similar techniques.

Building of the frequency filter can includes determining the mathematical expression of the filter, which can correspond to a polynomial expression, or to other adapted expression, for which coefficients need to be found.

For example, for the frequency filter with a transfer function as depicted in FIG. 4B (which is described hereinafter), this can include determining a piecewise function H(f) for different frequency ranges.

In the frequency range from F₁ to F₄, a function that amplifies the input signal can be selected, such as a raised-cosine quarter wave (this is not limitative). In the frequency domain from F₄ to F₅, a polynomial function (such as H′(f+a)=f²+b, with a and b real values to be determined) can be used. In the frequency domain from F₅ to F₆, a rectangular function multiplied by a constant can be used. In the frequency domain from F₆ to F₃, an exponential function can be used (H″(f)=e^{-αf}, with α a value to be determined). For the frequency range which is above F₃, a function H′″(f)=0 can be used. Based on the different intermediate functions that have been determined, the mathematical expression H(f) of the frequency filter can be obtained. In some embodiments, interpolation can be applied to smooth-out the final transfer function of the transfer function.

Building of the transfer function of the filter can include e.g. use of a tool such as Matlab. This is however not limitative.

A non-limitative example of a transfer function of the filter is represented in FIG. 4A. Assume that the range of frequencies [F₁;F₃] is defined as representative of frequencies of an earthquake.

In this non-limitative example, a substantially linear behaviour has been chosen for the transfer function.

As shown, frequencies of the input signal of the filter located in the range [F₁;F₂] are amplified. Frequencies located in the range [F₂;F₃] (F₁<F₂<F₃) are attenuated.

In each range ([F₁;F₂] and [F₂;F₃]), lower frequencies are more amplified relative to higher frequencies.

This example is not limitative.

Another non-limitative example of a transfer function is illustrated in FIG. 4B. Assume that the range of frequencies [F₁;F₃] is representative of a range of frequencies of an earthquake. Assume also that F₁<F₄<F₅<F₆<F₃.

In this example, a nonlinear behaviour of the transfer function has been selected.

As shown, “high” frequencies located in the frequency band [F₆;F₃] are strongly attenuated (more than all frequencies located in the “low” frequency band [F₁;F₆]).

In addition, in the “low” frequency band [F₁;F₆], a plurality of first subsets of frequencies are amplified. A second subset of frequencies are less amplified than the first subsets, and even attenuated.

In particular, frequencies in the frequency band [F₁;F₄] and in the frequency band [F₅;F₆] (first subsets of frequencies) are amplified. Frequencies in the frequency band [F₄;F₅] (second subset of frequencies) are attenuated.

In addition, [F₁;F₄] and [F₅;F₆] do not constitute a continuous range of frequencies (since these two frequency bands are interrupted by frequency band [F₄;F₅]), thereby allowing selective amplification, as already explained above.

Application of the frequency filter can include selecting a time window for the signal (motion data). In some embodiments, a rectangular window can be used to select the time window of the signal. In some embodiments, a window function (Hann, Hamming or Blackman for example) can be applied.

The signal within this time window can be converted into a frequency representation. This conversion can include using FFT.

The converted signal can be then multiplied with the transfer function of the frequency filter (H(f) in the example above).

For each time window, after application of the frequency filter, the filtered data can be converted back to a time representation (using e.g. inverse FFT, or similar techniques), in order to obtain filtered data FD.

This filtered data FD can correspond to a new signal (temporal signal FD(t)) for each time window, after filtering.

The method can comprise comparing (operation 420) data representative of this new signal to at least one threshold. Data representative of this new signal includes in particular amplitude of the new signal. This comparison can be performed at one or more time instants.

If this comparison indicates that the amplitude of the filtered data exceeds the threshold, this can be indicative that an earthquake has been detected. In some embodiments, as explained hereinafter, an alert is raised only if the threshold is exceeded more than once, and during predefined time windows (see FIGS. 11 and 12).

A non-limitative example of the comparison is illustrated in FIG. 4C, in which the filtered data FD (represented as a continuous signal for the purpose of illustration, but this signal is generally a discrete signal) is represented over a plurality of time windows TW. As shown, the amplitude of the filtered signal is compared to a threshold TH. During time windows TW5 and TW6, it has been detected that the filtered data exceeds threshold TH, which is an indication that an earthquake may occur.

Attention is drawn to FIG. 4D.

According to some embodiments, the method of FIG. 4 can be carried out based on motion data obtained for a plurality of axes.

The method can comprise obtaining motion data (operation 450) for a plurality of axes. For example, assume motion data is received for axis X, axis Y and axis Z (this is not limitative and this could apply also to only two axes).

For each axis, the method can comprise applying (operation 455) at least one filter to motion data obtained for this axis. In some embodiments, the filter can be similar to the filter described with reference to operation 410. As mentioned above, the filter can comprise a transfer function which amplifies frequencies within a range of frequencies representative of an earthquake, wherein this amplification is higher than for other frequencies of this range, to obtain (after reverting to time domain) filtered data FD.

Assume operation 455 is applied on motion data received along two different axes X and Y. As a consequence, for a given time window, filtered data FD_{X}(t) is obtained for axis X, and filtered data FD_{Y}(t) is obtained for axis Y.

According to some embodiments, the method can include comparing (operation 460), for each axis, amplitude of the filtered data to a threshold. This can include comparing FD_{X}(t) to threshold TH, and comparing FD_{Y}(t) to threshold TH (generally the same threshold is used, but this is not mandatory).

According to some embodiments, if all comparisons (along all axes) meet the threshold, or the majority of the comparisons (if more than two axes are used) meet the threshold, then this can be considered as an indication that an earthquake is about to occur (in some embodiments, this can trigger an alert, or in other embodiments, as explained hereinafter, the method can comprise waiting to see whether the threshold is met again before triggering an alert, as explained with reference to FIGS. 11 and 12).

According to other embodiments, the method can include (operation 465) computing an aggregated output common to all axes. This can include e.g. computing an aggregated output FD_{X,Y}(t)=\sqrt{FD_{X}(t)²+FD_{Y}(t)²}. This equation is however not limitative, and other equations can be used.

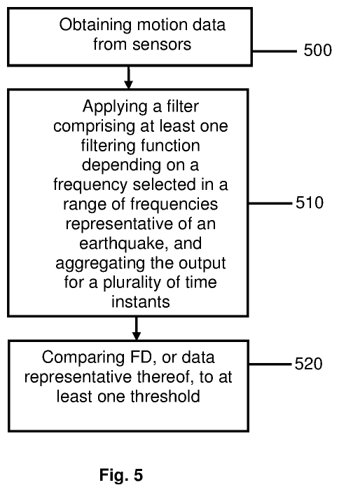

Attention is now drawn to FIG. 5 which describes another possible embodiment of a method of detecting an earthquake. This method is in accordance with the method of FIG. 3, but relies on a different filtering process.

The method can include obtaining (operation 500) motion data from sensors. This operation is similar to operation 300 above.

The method can comprise applying (operation 510) a filter comprising at least one filtering function (expressed as a time signal) depending on a frequency f₁ selected in a range of frequencies representative of an earthquake. This can comprise, in particular, multiplying motion data (time signal) by the filtering function.

As explained hereinafter, the filtering function can comprise a main frequency f₁ (main frequency component of the function, also called dominant frequency) in a range of frequencies representative of an earthquake.

In some embodiments, the filtering function can comprise a single frequency f₁. For example, the function can correspond to a sinusoidal wave.

In some embodiments, and as explained hereinafter, the filtering function can be formulated using a complex expression.

Aggregation of the output of this filtering operation for a plurality of time instants provides filtered data FD, and helps differentiating between noise and motion data originating from an earthquake.

In this embodiment, the filter is therefore operative to at least apply at least one filtering function to the motion data at a plurality of time instants to obtain an output for each time instant, and to aggregate the output for the plurality of time instants.

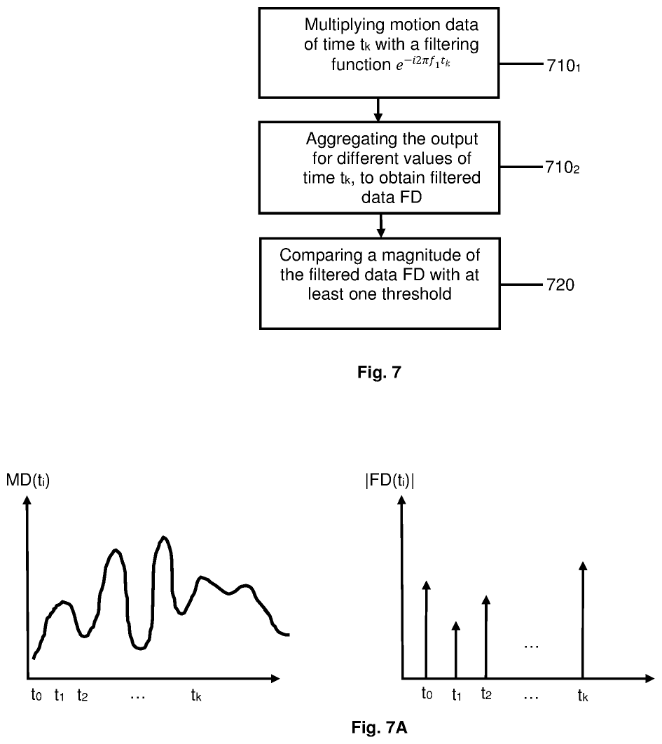

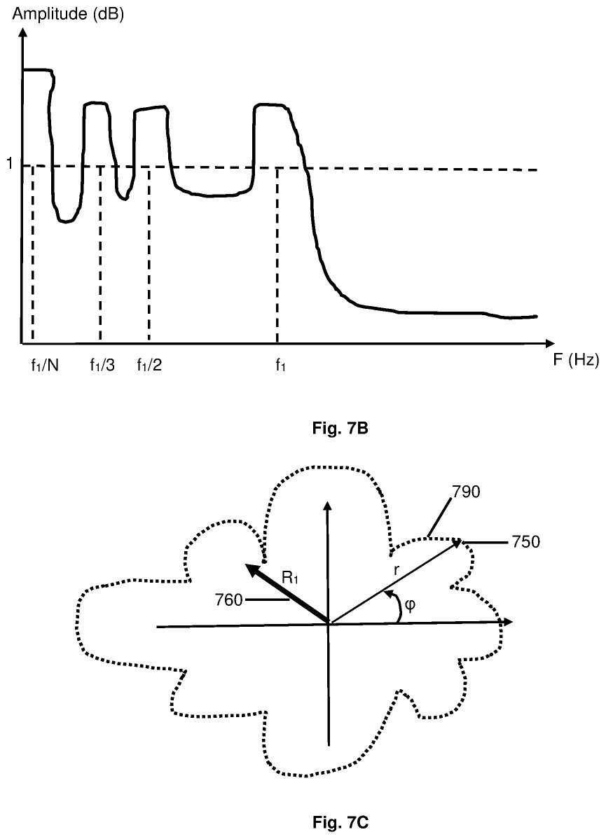

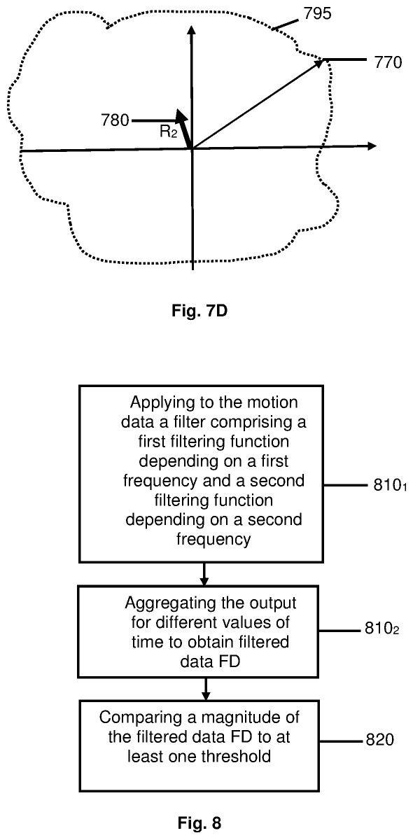

As a consequence of this filtering process, frequency components of the input signal which are equal to f₁, or which are sub-harmonics of f₁ (e.g. f1/N, with N an integer different from 0) are amplified in the filtered data FD, whereas other frequencies are less amplified or even attenuated. A non-limitative example of a transfer function of the filtering process is depicted in FIG. 7A.

As a consequence, a selective amplification is obtained, in which only a subset of frequencies will be amplified (the other frequencies are attenuated or less amplified) within a range of frequencies representative of an earthquake, wherein the subset of frequencies which are amplified is not a continuous range but is rather spread discontinuously within the range of frequencies representative of an earthquake.

In particular, according to some embodiments, the filtering process converts the motion data received over a period of time into filtered data FD, wherein the more the motion data comprises frequency components corresponding to f₁ (and/or to sub-harmonics of f₁) which are more amplified by the filter, the higher the value of data representative of the filtered data FD.

The method can include (operation 520) data representative of the filtered data FD to a threshold. As explained hereinafter, data representative of the filtered data FD can include magnitude of the filtered data FD.

If this comparison indicates that data representative of the filtered data exceeds the threshold, this can be indicative of whether an earthquake has been detected. In some embodiments, as explained hereinafter, an alert is raised only if the threshold is exceeded more than once, and during predefined time windows (see e.g. FIGS. 11 and 12).

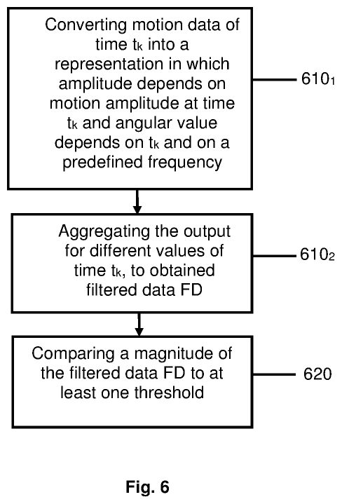

Attention is now drawn to FIG. 6, which describes a possible implementation of the method of FIG. 5.

Assume motion data MD(tₖ) is received from the sensors for various values of time (that is to say for different values of integer k).

The filtering function can be used to filter the motion data at a plurality of time instants tₖ, in order to obtain an output V(tₖ) for each time instant tₖ.

According to some embodiments, the method can include (operation 610₁) converting (using this filtering function) motion data of time tₖ into a representation (which can be in particular viewed as a 2D vector V(tₖ) in a plane) for which:
amplitude of this representation V(tₖ) depends on motion amplitude of the motion data at time tₖ; and
angular value of this representation V(tₖ) (e.g. angular inclination of the vector) depends on tₖ and on at least the predefined frequency f₁.

In some embodiments, the representation can be a complex representation, which is obtained by applying a complex filtering function which depends on the predefined frequency f₁ and which is applied to the motion data.

For example, a complex filtering function TF_{com}(tₖ, f₁) can be used, wherein f₁ is the predefined frequency. According to some embodiments, a dominant frequency of this filtering function is equal to this frequency, or is a multiple of this frequency.

According to some embodiments, the complex filtering function has a single frequency component, which is equal to the predefined frequency f₁.

A complex number a+i.b can be represented by the Euler formula r.e^{iϕ}, and therefore, after operation 610₁, the amplitude of the complex output can correspond to “r” and the angular value of the complex output can correspond to “ϕ”. This representation can be visualized in two dimensions as a vector in a 2D plane, wherein “r” is the size of the vector and “ϕ” (or ϕ/2.π in radians) is the angular inclination of the vector (polar representation).

The method can comprise, aggregating (operation 610₂) the output of operation 610₁ for different values of time (e.g. over a time window), in order to obtain an aggregated output (filtered data FD for this time window).

In some embodiments, the aggregation can include performing a weighted combination of the output of operation 610₁ for different values of time.

In some embodiments, operation 610₂ is repetitively performed for different values of time, and each time new motion data is processed according to operation 610₁, it is then aggregated with the current value of the aggregated output.

For example, assume an aggregated output is FD(tₖ) at time tₖ (representative of a time window from time t₀ to time tₖ). Then, when new motion data of time tₖ₊₁ is processed at operation 610₁, the output is then aggregated with FD(tₖ) in order to obtain an updated aggregated output FD(tₖ₊₁).

If the filtering function is a complex function, the aggregated output can be represented by a complex representation, and equivalently, by a vector characterized by coordinates (in an Euclidian representation) or by a radius and an angle (in a polar representation).

Magnitude of the filtered data FD for a time window is representative of the correlation between the frequency components of the collected motion data (input signal) and the frequency f₁ (and its sub-harmonics) in this time window.

In particular, an effect of the filtering operation (in particular after application of the filtering function which depends on frequency f₁ and aggregation over a time window) is to amplify frequency f₁ and its sub-harmonics, and to attenuate other frequencies. A selective amplification is thus obtained (in FIGS. 4 to 4D, a selective amplification has also been described but using another filtering process).

As a consequence, magnitude of the filtered data FD obtained for noise and magnitude of the filtered data FD obtained for a true earthquake are expected to be different (in particular, in some embodiments, the magnitude of the aggregated output is expected to be higher for an earthquake than for environmental noise).

As shown in FIG. 6, the magnitude of the aggregated output can be compared (operation 620) to at least one threshold. In particular, the radius (in the polar representation—in the Euclidian representation, this corresponds to the length of the vector) of the aggregated output can be compared to the threshold.

This comparison can be performed at each time tₖ, or in some embodiments, at certain time intervals, as explained hereinafter.

Based on this comparison, an alert can be raised indicating that an earthquake has been detected (see also FIGS. 11 and 12 for possible embodiments relative to triggering of the alert).

Attention is drawn to FIG. 7 which describes an example of implementation of the method of FIGS. 5 and 6.

Assume motion data MD(tₖ) is received from the sensors for various values of time (that is to say for values of k).

As shown, according to some embodiments, the method can comprise (operation 710₁) multiplying the motion data at time tₖ with a filtering function, which can be selected as follows:

TF(tₖ)=S·e^{-i2πf}^{₁}^{t}^{ₖ} (Equation 1)

In this Equation, S is a parameter, which can be e.g. selected by an operator and can be equal to one. Hereinafter, S is set equal to one, but this is not limitative.

Therefore, at operation 710₁, the following output is obtained for each time tₖ:

MD(tₖ)·e^{-i2πf}^{₁}^{t}^{ₖ} (Equation 2)

At operation 710₂, an aggregation of the output of operation 710₁ can be performed for different values of tₖ (for example for time window from t₀ to t_{N}), as illustrated by the equation below:

FD(t_{N})=Σₖ₌₀^{k=N}MD(tₖ)·e^{-i2πf}^{₁}^{t}^{ₖ} (Equation 3)

In this formula, FD (t_{N}) corresponds to filtered data FD for the time window between t₀ to t_{N}. It is an aggregated output, which takes into account the output of operation 710₁ for time instants from t₀ to t_{N}.

When a new value of the motion data MD₍ₜ_{_{N+1}}₎ is received at time t_{N+1}, then the filtering function (Equation 1) can be applied to this new value, and the output (MD(t_{N+1}).e^{-i2πf}₁t_{N+1}) can be added to the previous value (FD(t_{N})) in order to obtain an updated aggregated value (FD(t_{N+1})).

In some embodiments, the aggregation can comprise performing a weighted combination of the output of operation 710₁ for different values of time. As shown in FIG. 7, the magnitude of the aggregated output (e.g. absolute value) can be compared (operation 720) to at least one threshold. In particular, the radius (the radius corresponds to a polar representation—in the Euclidian representation, this corresponds to the length of the vector) of the aggregated output can be compared to the threshold.

This comparison can be performed at each time tₖ, or in some embodiments, at certain time intervals, as explained hereinafter.

Based on this comparison, an alert can be raised indicating that an earthquake has been detected.

As mentioned above, data representative of the filtered data for a true earthquake is expected to be different than for noise (in particular, in some embodiments, the radius of the magnitude of the filtered data is expected to be higher for an earthquake than for environmental noise).

FIG. 7B shows a non-limitative example of a transfer function depicting the effect of the filtering process of FIGS. 5 to 7. The representation is schematic. This transfer function is not limitative and various other profiles can be used for the transfer function.

As shown in FIG. 7A, the filtering process provides a conversion of the motion data MD(tᵢ) into a magnitude (magnitude of FD (tᵢ), which corresponds to a magnitude of filtered data FD from time window from t₀ to tᵢ).

The transfer function of FIG. 7B is representative of the ratio between the spectral representation (e.g. Fourier transform) of an output of the filtering process (magnitude of FD(tᵢ), which is representative of time window from t₀ to tᵢ) and the spectral representation of the input of the filtering process (signal MD over the corresponding time window from t₀ to tᵢ). As visible in FIG. 7B, all frequencies of the input signal which are equal to f₁, or which are sub-harmonics of f₁ (e.g. f₁/N, with N an integer different from 0) are amplified, whereas other frequencies are attenuated. In addition, frequencies which are higher than f₁ are strongly attenuated.

If more than one filtering function is used (as explained e.g. in FIG. 8), then a different transfer function can be obtained, in which a plurality of different frequencies representative of earthquake are amplified, whereas other frequencies are attenuated.

FIGS. 7C and 7D illustrate a possible example of an output of the method of FIG. 7. This example is not limitative and is purely illustrative.

Assume an earthquake is occurring. As mentioned above, motion data MD(tₖ) can be converted e.g. in a complex representation, by the filtering function, which can be visualized e.g. as a vector in a 2D plane. This visualization is not limitative and is merely provided as an illustration of possible effects of the method.

FIG. 7C illustrates various extremities 790 of different vectors 750 obtained for different time values tₖ.

Each vector 750 has been obtained following operation 710₁. The size (magnitude) of vector 750 obtained at time tₖ is equal (in the example of FIG. 7B) to r=MD(tₖ) and its angle is equal to φ=2πf₁tₖ.

At operation 710₂, the vectors are summed and an aggregated vector 760 is obtained.

FIG. 7D illustrates similar operations for motion data MD(tₖ) representative of environmental noise.

Various extremities 795 of different vectors 770 are illustrated.

Each vector 770 has been obtained following operation 710₁. The size of vector 770 obtained at time tₖ is equal (in the example of FIG. 7B) to r=MD(tₖ) and its angle is equal to φ=2πf₁ tₖ.

At operation 710₂, the vectors are summed and an aggregated vector 780 is obtained.

As shown, the size (magnitude) R₂ of the aggregated vector 780 is smaller than the size R₁ of the aggregated vector 760. This is in particular due to the fact that the different elementary vectors 770 obtained for the noise tend to “cancel” each other, thereby providing an aggregated vector of small size, which is less than the case of the elementary vectors 750 of the earthquake signal.

This effect is in particular due to the fact that the earthquake generally comprises, in its frequency spectrum which is generally larger than the frequency band of a noise, a frequency equal to f₁ (which was selected to be in a range relevant for earthquake), and/or equal to a sub-harmonic of f₁, which is less likely for the noise. Further differentiation between the earthquake and the noise can be improved (as explained hereinafter), by using e.g. more than one filtering function, and/or by triggering an alert only if a specific alerting criteria is met (see e.g. FIGS. 11 and 12).

By comparing the size (magnitude) of the aggregated vector to a threshold, it is thus possible to differentiate between motion data representative of an earthquake and motion data representative of noise. In particular, if the size of the aggregated vector is above the threshold, there is a probability that an earthquake is occurring.

Attention is now drawn to FIG. 8.

According to some embodiments, the filter comprises at least two filtering functions. This can help to further improve differentiating between noise and an earthquake.

A method can include (operation 810₁) applying a filter comprising a first filtering function TF₁(tₖ) depending on a first predefined frequency f₁ to the motion data, and a second filtering function TF₂(tₖ) depending on a second predefined frequency f₂ to the motion data, wherein f₂ is different from f₁ (although an example with two transfer functions is provided, this applies similarly to N filtering functions, with N>1). Frequencies f₁ and f₂ are generally selected to be both in a range of frequencies representative of an earthquake.

In particular, according to some embodiments, a dominant frequency of the first (resp. second) filtering function is equal to the first (resp. second) frequency, or is equal to a multiple of this first (resp. second) frequency.

According to some embodiments, the first (resp. second) filtering function has a single frequency component (e.g. sinusoidal wave), which is equal to the first (resp. second) frequency.

According to some embodiments, operation 810₁ can be performed according to Equation 4 (MD(tₖ) corresponds to collected motion data at time tₖ):

MD(tₖ)·TF₁(tₖ)+MD(tₖ)·TF₂(tₖ) (Equation 4)

According to some embodiments, the output of operation 810₁ can be obtained as a weighted combination of the motion data with each of the first and second filtering functions, as expressed by e.g. Equation 5:

MD(tₖ)·S₁·TF₁(tₖ)+MD(tₖ)·S₂·TF₂(tₖ) (Equation 5)

S₁ and S₂ are weighting parameters, and if S₁>S₂, then more weight is given to the effect of the first filtering function, and if S₁<S₂, then more weight is given to the effect of the second filtering function.

The method can further comprise aggregating (operation 810₂) the output of operation 810₁ for different values of time, in order to obtain an aggregated output.

The aggregation can be performed over a time window (from t₀ to t_{N}) e.g. according to Equation 6:

FD(t_{N})=Σₖ₌₀^{k=N}MD(tₖ)·S₁·TF₁(tₖ)+MD(tₖ)·S₂·TF₂(tₖ) (Equation 6)

In some embodiments, operation 810₁ is repetitively performed for different values of time, and operation 810₂ provides an aggregation of the output up to time t_{N}. Each time new motion data is processed according to operation 810₁, it is then aggregated with the current value of the aggregated output.

For example, assume an aggregated output is FD(t_{N}) at time t_{N}. Then, when new motion data of time t_{N+1} is processed according to operation 810₁, the output is then aggregated with FD(t_{N}) in order to obtain an updated aggregated output FD(t_{N+1}).

As shown in FIG. 8, the magnitude of the filtered data FD can be compared (operation 820) to at least one threshold. This comparison can be performed at each time tₖ, or in some embodiments, at certain predefined time intervals, as explained hereinafter.

According to some embodiments, the first and second transfer functions are complex functions.

A non-limitative example is the function of Equations 1 and 2.

Therefore, at operation 810₁, the following operations can be performed:

MD(tₖ)·e^{-i2πf}^{₁}^{t}^{ₖ}+MD(tₖ)·e^{-i2πf}^{₂}^{t}^{ₖ} (Equation 7), or

MD(tₖ)·S₁·e^{-i2πf}^{₁}^{t}^{ₖ}+MD(tₖ)·S₂·e^{-i2πf}^{₂}^{t}^{ₖ} (Equation 8)

At operation 810₂, the following operation can be performed, in order to obtain an aggregated output over a time window from t₀ to t_{N}:

FD(t_{N})=Σₖ₌₀^{k=N}MD(tₖ)·S₁·e^{-i2πf}^{₁}^{t}^{ₖ}+MD(tₖ)·S₂·e^{-i2πf}^{₂}^{t}^{ₖ} (Equation 9)

The magnitude of the filtered data FD can be compared (operation 820) to at least one threshold. In particular, the radius (the radius corresponds to a polar representation—in the Euclidian representation, this corresponds to the length of the vector representative of the aggregated output) of the aggregated output, can be compared to the threshold.

Based on this comparison, an alert that an earthquake is occurring can be triggered (if the amplitude is above the threshold).

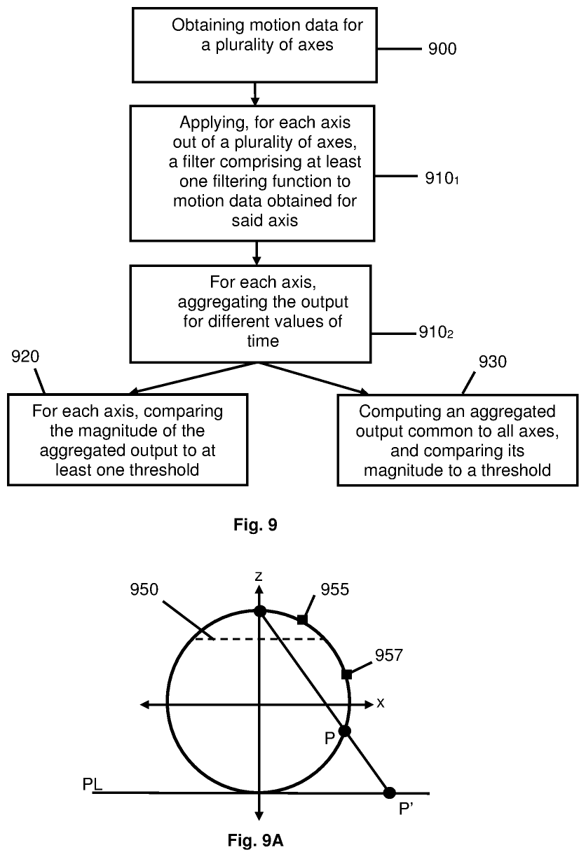

Attention is now drawn to FIG. 9.

A method can comprise obtaining motion data (operation 900) for a plurality of axes. For example, assume motion data is received for axis X, axis Y and axis Z (this is not limitative and this could be applied also to only two axes.

For each axis, the method can comprise applying (operation 910₁) a filter comprising at least one filtering function to motion data obtained for this axis over a time window (e.g. from time t₀ to t_{N}).

This can comprise, for each axis, using the various methods already described above, and in particular, operation 910₁ can comprise e.g.:
performing operation 610₁ of FIG. 6;
performing operation 710₁ of FIG. 7;
performing operation 810₁ of FIG. 8.

In some embodiments, the same filtering function(s) can be used for the horizontal plane including axis X and Y (examples of filtering functions are provided above, see TF, TF₁. TF₂).

For each axis, an aggregated output FD_{X}(t_{N}), FD_{Y}(t_{N}) and FD_{Z}(t_{N}) can be computed (operation 910₂) for a time window (from time t₀ to time t_{N}).

This can comprise using the various methods already described above, and in particular, operation 910₂ can comprise e.g.:
performing operation 610₂ of FIG. 6;
performing operation 710₂ of FIG. 7;
performing operation 810₂ of FIG. 8.

According to some embodiments, the method can include comparing (operation 920), for each axis X (resp. Y and Z), magnitude of the filtered data FD_{X}(t_{N}) (resp. FD_{Y}(t_{N}) and FD_{Z}(t_{N})) with a threshold (the threshold can be the same for all axes, or different).

According to some embodiments, if all comparisons meet the threshold, or the majority of the comparisons meet the threshold, this can trigger an alert, or in other embodiments, as explained hereinafter, the method can comprise waiting to see whether the threshold is met again before triggering an alert (see FIGS. 11 and 12).

According to other embodiments, the method can comprise (operation 730) computing an aggregated output FD_{X,Y,Z}(t_{N})) common to all axes (for time window from t₀ to t_{N}).

According to some embodiments, the aggregated output FD_{X,Y,Z}(t_{N}) can be computed as the magnitude of an aggregated vector (in a three dimensional space) built based on a magnitude of vector FD_{X}(t_{N}), a magnitude of vector FD_{Y}(t_{N}) and a magnitude of vector FD_{Z}(t_{N}). In particular, the aggregated vector can have the following coordinates:

$$[ \begin{matrix}\vert {FD}_{X} ( {t}_{N} ) \vert \\ \vert {FD}_{Y} ( {t}_{N} ) \vert \\ \vert {FD}_{Z} ( {t}_{N} ) \vert\end{matrix} ]$$

Equation 9 can be used to compute the amplitude of the aggregated output FD_{X,Y,Z}(t_{N}):

FD_{X,Y,Z}(t_{N})=\sqrt{|FD_{X}(t_{N})|²+|FD_{Y}(t_{N})|²|FD_{Z}(t_{N})|²} (Equation 9)

Another aggregation method is depicted in FIG. 9A.

Assume a vector V_{X,Y}(t_{N}) (in a two dimensional space) is built with the following coordinates:

$$[ \begin{matrix}\vert {FD}_{X} ( {t}_{N} ) \vert \\ \vert {FD}_{Y} ( {t}_{N} ) \vert\end{matrix} ]$$

In other words, motion data collected along a vertical axis (Z axis) is first ignored.

There is a mathematical transformation (Stereographic projection) which allows converting points located on a 2D plane into points located on a surface of a sphere (and conversely).

Assume a sphere with a radius equal to unity has its “north pole” N located at Cartesian coordinates (x,y,z)=(0,0,1). Assume M is any point of the surface of the sphere which is not N. Assume a plane PL is fixed at z=−1. For every point P on the sphere M (apart from N), there is a unique line from N to P that intersects the plane PL at point P′.

According to some embodiments, operation 930 can comprise applying this mathematical transformation to the vector V_{X,Y}(t_{N}), in order to convert the vector from a representation in plane PL to a point on the surface of the sphere.

In a 2D plane, the amplitude of the vector is compared to a threshold. In the new representation (surface of a sphere), the threshold corresponds to a ring 950 located in an upper part of the sphere. If a point (obtained from a vector in a 2D plane) is located above or at this ring 950, then the threshold is met, and if not, the threshold is not met.

For example, point 955 meets the threshold (since it is located above ring 950).

To the contrary, point 957 does not meet the threshold (since it is located below ring 950).

According to some embodiments, motion data MD_{Z}(tₖ) (collected along the vertical Z axis) is processed according to any of the methods described above (see FIGS. 3, 4, 5, 6, 7, 8), in which motion data is converted to filtered data FD_{Z}, and data representative thereof is compared to a threshold.

If the threshold is not met, then the position of plane PL is not changed.

If the threshold is met, then this is a further indication that an earthquake is occurring. As a consequence, the position of plane PL can be changed so that its vertical position z is moved upwards towards a new position z_{new}, with −1<z_{new}<zₘₐₓ<1. In other words, sensitivity is increased. As a consequence, the probability that the point of the sphere representative of the V_{X,Y}(t_{N}) will be above the ring 950 is increased.

In some embodiments, the higher the data representative of filtered data FDz (which indicates high probability of an earthquake), the higher the value of z_{new}. However, a maximal position zₘₐₓ can be assigned.

According to other embodiments, once V_{X,Y}(t_{N}) has been built, an amplitude of this vector can be weighted based on motion data collected along the vertical Z axis.

In particular, assume motion data MD_{Z}(tₖ) is collected along the vertical Z axis over a period of time. This motion data can be processed according to any of the methods described above (see FIGS. 3, 4, 5, 6, 7, 8), in which motion data is converted to filtered data FDz, and data representative thereof is compared to a threshold. If the threshold is met, then this is a further indication that an earthquake is occurring. As a consequence, the amplitude of vector V_{X,Y}(t_{N}) can be weighted accordingly (in particular, a coefficient which increases amplitude of vector V_{X,Y}(t_{N}) can be applied if the threshold is met for filtered data FDz. The coefficient can be selected based e.g. on simulations, and/or can be set by an operator).

As a consequence, the prospects that vector V_{X,Y}(t_{N}) will meet the threshold are increased. In the 2D representation this corresponds to increasing the length of the vector, and in the representation involving a surface of a sphere, this corresponds to moving the point representative of the vector towards the extreme part of the sphere.

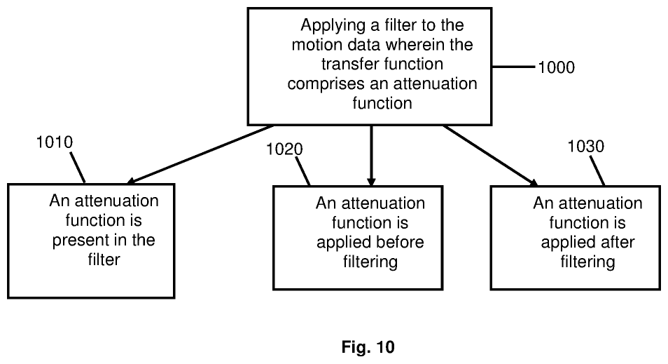

Attention is now drawn to FIG. 10.

According to some embodiments, a method can comprise applying (operation 1000) an attenuation function to the motion data. The attenuation function tends to attenuate amplitude of collected motion data over time. The attenuation function generally corresponds to a time signal.

According to some embodiments, the attenuation function can be part of the filter (various embodiments of the filter have been described above, see FIGS. 5 to 8). This is shown in operation 1010.

For example, the filter comprises a filtering function and the attenuation function (the filter can include e.g. a multiplication of these two functions).

According to some embodiments, motion data is first filtered and the attenuation function is then applied to the filtered data (see operation 1020).

According to some embodiments, the attenuation function is first applied to the motion data, and then a filtering is performed (see operation 1030).

Use of the attenuation function helps further differentiating between motion data originating from an earthquake and motion data originating from environmental noise. Indeed, environmental noise generally tends to have an amplitude which decreases with time, whereas an earthquake has an amplitude which can be constant or even increase, thereby counterbalancing effect of the attenuation function more efficiently than environmental noise. As a consequence, the aggregated output obtained for noise will not meet the threshold, whereas the aggregated output obtained for an earthquake signal will meet the threshold.

Examples of attenuation functions include e.g. decay functions, exponential functions, etc. The attenuation function can comprise a combination (e.g. multiplication) of different types of attenuation functions.

A non-limitative example of an attenuation function can be expressed as follows:

AT(tₖ)=e^{-λt}^{ₖ}(whereinλis a decay rate,which is a constant real value), or AT(tₖ)=rtₖ(whereinr is a decay rate,which is a constant real value) (Equation 10)

Various filtering operations have been described above.

In some embodiments, the filter comprises a filtering function TF(tₖ) which comprises a complex function (see e.g. Equation 1). Therefore, the filtering function can be multiplied by the attenuation function, as illustrated in Equation 11:

TF(tₖ)=S·e^{-i2πft}^{ₖ}·AT(tₖ) (Equation 11)

The attenuation function can be used in the various embodiments described above.

For example, Equation 2 can be modified to Equation 12:

MD(tₖ)·e^{-i2πf}^{₁}^{t}^{ₖ}·AT(tₖ) (Equation 12)

Similarly, Equation 3 can be modified to Equation 13 which describes the discrete convolution of the product of MD(tₖ) and TF(tₖ) with AT(tₖ)−[MD.TF*AT(tₖ)]:

FD(t_{N})=Σₖ₌₀^{k=N}MD(tₖ)·e^{-i2πf}^{₁}^{t}^{ₖ}·AT(N−k) (Equation 13)

Similarly, Equation 5 can be modified to Equation 14 (as shown below, different attenuation functions can be used for the different filtering functions TF₁ (tₖ) and TF₂(tₖ)):

MD(tₖ)·S₁·TF₁(tₖ)·AT₁(tₖ)+MD(tₖ)·S₂·TF₂(tₖ)·AT₂(tₖ) (Equation 14)

Similarly, Equation 6 can be modified to Equation 15:

$$FD ( {t}_{N} ) = {\sum }_{k = 0}^{k = N} MD ( {t}_{k} ) . {S}_{1} . {TF}_{1} ( {t}_{k} ) . {AT}_{1} ( N - k ) + MD ( {t}_{k} ) . {S}_{2} . {TF}_{2} ( {t}_{k} ) . {AT}_{2} ( N - k ) \qquad ( Equation 15 )$$

Similarly, Equation 8 can be modified to Equation 16:

MD(tₖ)·S₁·e^{-i2πf}^{₁}^{t}^{ₖ}·AT₁(tₖ)+MD(tₖ)·S₂·e^{-i2πf}^{₂}^{t}^{ₖ}·AT₂(tₖ) (Equation 16)

Similarly, Equation 9 can be modified to Equation 17:

$$FD ( {t}_{N} ) = {\sum }_{k = 0}^{k = N} MD ( {t}_{k} ) . {S}_{1} . {e}^{- i 2 π {f}_{1} {t}_{k}} . {AT}_{1} ( N - k ) + MD ( {t}_{k} ) . {S}_{2} . {e}^{- i 2 π {f}_{2} {t}_{k}} . {AT}_{2} ( N - k ) \qquad ( Equation 17 )$$

The attenuation function can be used also in the filtering function used for each axis at operation 910₁.

The filtered data (after filtering and attenuation) can be processed similarly to the various embodiments described above in order to detect whether an earthquake is occurring.

Attention is now drawn to FIG. 11.

FIG. 11 describes a method which can be used in combination with the various embodiments described above.

The method can comprise obtaining (operation 1100) motion data provided by one or more sensors 110. This operation is similar to operation 300 already described above.

As explained above, based on the motion data, filtered data FD is obtained (see the various embodiments above), and FD, or data representative thereof, is monitored and compared (operation 1110) to at least one threshold (see operations 320, 420, 460, 465, 520, 620, 720, 820, 920, 930). As mentioned, the filtered data can be representative of motion data collected along one, two or even three axes.

In order to further differentiate between motion data originating from an earthquake, and motion data originating from noise, the method can comprise performing the comparison with the threshold at different periods of time before triggering an alert.

Assume filtered data FD(t_{N}) is computed at time t_{N}.

A comparison of data representative of filtered data FD(t_{N}) with a first threshold is performed.

If a method as described e.g. in FIG. 4 is used, then the filtered data corresponds to a time signal (see e.g. FIG. 4C) whose amplitude is monitored over time. Amplitude of the filtered signal at time t_{N} is compared to the first threshold.

If a method as described e.g. in FIG. 6 (or FIGS. 7 to 9) is used, then the filtered data FD(t_{N}) can correspond to a magnitude of aggregated data accumulated over a period of time, e.g. from time to (time at which collection of motion data has started) to time t_{N}.

Whatever the method which is used, if the comparison reveals that FD(t_{N}), or data representative thereof, exceeds the first threshold, the method can comprise triggering (operation 1120) a first time window (see FIG. 12). In FIG. 12, amplitude of the signal corresponds to amplitude of the filtered data FD (which can be computed according to any of the methods described above).

The first time window can be viewed as a waiting period, from time t_{N+1} to time t_{N+M}. During this waiting period, further motion data is collected, and therefore, updated filtered data FD is obtained. Even if this updated filtered data FD, or data representative thereof, exceeds again the first threshold, an alert is not triggered. This is illustrated in FIG. 12.

The method can comprise, upon completion of the first time window, triggering (operation 1130) a second time window, from time t_{N+M+1} to time t_{N+M+P}.

During the second time window, additional motion data is collected, and therefore, updated filtered data FD is obtained. Constant monitoring of the updated filtered data, or data representative thereof (updated e.g. each time new data is received within the second time window), with respect to at least one second threshold, is performed within the second time window (operation 1140). In some embodiments, the second threshold is set equal to the first threshold, but this is not mandatory.

If a method as described e.g. in FIG. 4 is used, then the updated filtered data of the second time window corresponds to a time signal whose amplitude is monitored during the second time window, with respect to the at least one second threshold.

If a method as described e.g. in FIG. 6 (or FIGS. 7 to 9) is used, then the updated filtered data can correspond to aggregated data accumulated over a period of time. This period of time can start e.g. from to up to the current time located in the second time window. Each time new motion data is received, the aggregated data is updated and takes into account all data up to the current data. As already explained, the aggregated data can be viewed as the magnitude of a vector obtained by filtering motion data.

If, during the second time window, the filtered data, or data representative thereof, exceeds the second threshold once, or a plurality of times N>1 (which can be pre-set by an operator), then the alerting criteria is met, and the method can comprise generating (operation 1150) an alert indicating that an earthquake has been detected. This is illustrated in FIG. 12.

If, after completion of the second time window, the alerting criteria has not been met, the method can return to operation 1110.

According to some embodiments, in the method depicted in FIGS. 5 to 9 in which the magnitude of aggregated data accumulated over a period of time is computed, this magnitude can be reset to zero, but this is not mandatory.

The use of the first and second time windows is beneficial to further reduce false alerts. Indeed, it could occur that a particular noise, which comprises frequency components similar to an earthquake, causes the filtered data to exceed the threshold. This would cause triggering of the first time window. However, the probability that, after a waiting time, the noise will again cause data representative of the filtered data to exceed the threshold, is low. This is due to the fact that motion data originating from noise generally tends to attenuate with time, in contradistinction to motion data originating from an earthquake that maintains, or even increases, its energy overt time.

Therefore, this helps further differentiating between noise and an earthquake.

In some embodiments, and as described with reference to FIG. 10, an attenuation function can be applied to the motion data (together with the filtering of the data).

In this case, the probability that data representative of the filtered data computed from motion data originating from a noise will exceed the threshold, both in the first time window and in the second time window, is further lowered, since amplitude of the motion is attenuated over time, in addition to the natural attenuation of noise relative to an earthquake.

Duration of the first and second time windows can be pre-set, and can be selected depending on the nature of the earthquake that needs to be detected.

The longer the first time window, the lower the probability that a false alarm (detection of noise as an earthquake) will be raised. However, the longer the first time window, the higher the time response to trigger the alert. Therefore, a compromise between these two factors can be performed by an operator who selects the duration of the first time window.

Typical examples of duration of the first time window is 0.1 s-2.5 s

Typical examples of duration of the second time window is 0.5 s-5 s

These values are however not limitative.

The method of FIGS. 11 and 12 (in which a first and second time windows are used) can be used with other methods in which motion data collected from sensors is converted into data representative of its amplitude and/or spectral distribution, in order to detect an earthquake.

It has been referred in the present specification to a range of frequencies representative of an earthquake. As already mentioned, an earthquake is generally not a sinusoidal wave, and therefore motion data of the earthquake generally comprises a dominant frequency and others frequencies located in a frequency band. In the majority of cases, the lower the dominant frequency of the earthquake, the higher its magnitude.

Range of frequencies representative of an earthquake can include:
In a range of]0 Hz;30 Hz] (or a sub-range located in this range);
In a range of]0 Hz;20 Hz] (or a sub-range located in this range);
In a range of]0 Hz;15 Hz] (or a sub-range located in this range);
In a range of]0 Hz;10 Hz] (or a sub-range located in this range);
In a range of]0 Hz;8 Hz] (or a sub-range located in this range).

In some embodiments, the first bound (greater than 0 Hz) of the range can include e.g. frequencies above 0.01 Hz, 0.1 Hz, etc.

If in a given location, it is known in advance which types of earthquake need to be detected (e.g. it is known than in this given location, earthquakes are generally of low frequency), then the range of frequencies in which the filter performs selective amplification (as explained in the various embodiments above) can be selected accordingly to match this type of earthquake, but this is not mandatory. For example, f₁ (see filtering function described above) can be selected to be located in this known range of frequencies for this location.

In the embodiment of FIG. 8, it has been described that a first filtering function (depending on frequency f₁) and a second filtering function (depending on frequency f₂) can be used. In some embodiments, f₁ is in range [0 Hz;10 Hz], and f₂ is in range]10 Hz;20 Hz]. This is not limitative.

It has been described above that in some embodiments, the filtering function provides more amplification to lower frequencies (hereinafter LF1) than to higher frequencies (hereinafter HF1) in the range of frequencies of an earthquake. In some embodiments, LF1 is in range [0 Hz;8 Hz], and HF1 is in range [8 Hz;20 Hz] or [8 Hz;30 Hz. This is not limitative.

It is to be noted that the various features described in the various embodiments may be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1-21. (canceled)

22. A system for detecting an earthquake, the system comprising:
a processor and memory circuitry configured to:
obtain motion data based on data collected by one or more sensors;
apply at least one filter on the motion data to obtain filtered data FD;
wherein the at least one filter is operative to, within at least one range of frequencies representative of an earthquake, amplify one or more frequencies of the motion data within the at least one range of frequencies, wherein the one or more frequencies are more amplified relative to other frequencies within the at least one range of frequencies;
compare, at least once, data representative of FD to at least one threshold; and
when this comparison meets an alerting criterion, generate an alert indicating that an earthquake has been detected.

23. The system of claim 22, wherein data representative of the filtered data FD comprises at least one value which is higher for motion data representative of an earthquake than for motion data representative of noise.

24. The system of claim 22, wherein the at least one range of frequencies representative of the earthquake is in an interval [0 Hz;30 Hz].

25. The system of claim 22, wherein the at least one range of frequencies representative of the earthquake is [F₁;F_{N}];
wherein the at least one filter is operative to amplify a plurality of frequencies Fᵢ, with F₁≤Fᵢ≤F_{N}, wherein the plurality of frequencies Fᵢ are more amplified than other frequencies wherein F₁≤Fⱼ≤F_{N};
wherein there is between at least two different frequencies Fᵢ of the plurality of frequencies Fᵢ at least one frequency Fⱼ.

26. The system of claim 22, wherein the at least one filter includes:
a frequency filter; or
at least one filtering function operable to be applied on the motion data for each of a plurality of time instants tₖ to obtain V(tₖ), wherein filtered data FD includes an aggregation of V(tₖ) over the plurality of time instants.

27. The system of claim 22, configured to:
when data representative of FD exceeds a first threshold, trigger a first time window; and
upon completion of the first time window, compute FD during a second time window and monitor FD during the second time window, wherein if data representative of FD exceeds a second threshold a number of times which is equal to N, generate an alert indicating that an earthquake has been detected, wherein N≥1.

28. A system for detecting an earthquake, the system comprising:
a processor and memory circuitry configured to:
obtain motion data based on data collected by one or more sensors;
apply at least one filter on the motion data to obtain filtered data FD, wherein the at least one filter includes a filtering function depending on at least one predefined frequency located in a range of frequencies representative of an earthquake;
compare data representative of FD to at least one threshold; and
when this comparison meets an alerting criterion, generate an alert indicating that an earthquake has been detected.

29. The system of claim 28, wherein the at least one filtering function includes a complex function.

30. The system of claim 28, configured to:
apply the at least one filtering function on the motion data for each of a plurality of time instants tₖ to obtain V(tₖ), and aggregating V(tₖ) over the plurality of time instants to obtain filtered data FD;
compare a magnitude of FD to at least one threshold; and
when this comparison meets an alerting criterion, generate an alert indicating that an earthquake has been detected.

31. The system of claim 30, wherein a magnitude of V(tₖ) is correlated to the amplitude of the motion data at time tₖ, and a direction of V(tₖ) is correlated to tₖ and to the predefined frequency.

32. The system of claim 28, wherein the at least one filter includes at least one decay function configured to attenuate, over time, amplitude of data to which it is applied.

33. The system of claim 28, configured to:
when data representative of FD exceeds a first threshold, trigger a first time window; and
upon completion of the first time window, compute FD during a second time window and monitoring FD during the second time window, wherein when data representative of FD exceeds a second threshold a number of times which is equal to N, generating an alert indicating that an earthquake has been detected, wherein N≥1.

34. The system of claim 28, wherein the at least one filter is configured to amplify frequency components corresponding to the predefined frequency, or to sub-harmonics of the predefined frequency.

35. The system of claim 28, wherein the at least one filter comprises:
at least one first filtering function depending on at least one first frequency located in a range of frequencies representative of an earthquake; and
at least one second filtering function depending on at least one second frequency located in a range of frequencies representative of an earthquake,
wherein the first frequency is different from the second frequency.

36. The system of claim 28, configured to:
obtain motion data (Mx, My) respectively collected along at least two different spatial axes (X, Y);
apply at least one filter on at least M_{X}, M_{Y} to obtain respectively filtered data FD_{X}, FD_{Y};
aggregate at least FD_{X}, FD_{Y} into an aggregated representation FD_{X,Y};
perform (i) or (ii);
(i):
compare, at least once, data representative of FD_{X,Y} to at least one threshold; and
when this comparison meets an alerting criterion, generate an alert indicating that an earthquake has been detected;
or
(ii):
obtain motion data Mz collected along a third axis Z, different from X and Y;
apply at least one filter on M_{Z} to obtain filtered data FDz;
weight the aggregated representation FD_{X,Y} based on FDz, to obtain FD_{X,Y,Z};
compare, at least once, FD_{X,Y,Z} to at least one threshold; and
when this comparison meets an alerting criterion, generate an alert indicating that an earthquake has been detected.

37. A method of detecting an earthquake, the method comprising:
by a processor and memory circuitry:
obtaining motion data based on data collected by one or more sensors;
filtering the motion data to obtain filtered data FD;
wherein the filtering comprises, within at least one range of frequencies representative of an earthquake, amplifying one or more frequencies of the motion data within the at least one range of frequencies, wherein the one or more frequencies are more amplified relative to other frequencies within the at least one range of frequencies;
comparing, at least once, data representative of FD to at least one threshold; and
when this comparison meets an alerting criterion, generating an alert indicating that an earthquake has been detected.

38. The method of claim 37, wherein the at least one range of frequencies representative of an earthquake is [F₁;F_{N}];
wherein the filtering is operative to amplify a plurality of frequencies Fᵢ, with F₁≤Fᵢ≤F_{N}, wherein the plurality of frequencies Fᵢ are more amplified than other frequencies wherein F₁≤Fⱼ≤F_{N};
wherein there is between at least two different frequencies Fᵢ of the plurality of frequencies Fᵢ at least one frequency Fⱼ.

39. The method of claim 37, wherein the filtering includes:
applying a frequency filter, or
applying at least one filtering function on the motion data for each of a plurality of time instants tₖ to obtain V(tₖ), and aggregating V(tₖ) over the plurality of time instants to obtain filtered data FD.

40. A method of detecting an earthquake, the method comprising:
by a processor and memory circuitry:
obtaining motion data provided by one or more sensors;
based on the motion data, determining filtered data representative of a spectral distribution of the motion data;
when data representative of the filtered data exceeds a first threshold, triggering a first time window;
upon completion of the first time window, computing filtered data representative of a spectral distribution of the motion data during a second time window; and
monitoring the filtering data during the second time window, wherein, when data representative of the filtered data exceeds a second threshold a number of times which is equal to N, generating an alert indicating that an earthquake has been detected, wherein N≥1.

41. A non-transitory computer readable medium, comprising:
instructions that, when executed by a processor and memory circuitry (PMC), cause the PMC to perform operations comprising:
obtaining motion data based on data collected by one or more sensors;
filtering the motion data to obtain filtered data FD;
wherein the filtering comprises, within at least one range of frequencies representative of an earthquake, amplifying one or more frequencies of the motion data within the at least one range of frequencies, wherein the one or more frequencies are more amplified relative to other frequencies within the at least one range of frequencies;
comparing, at least once, data representative of FD to at least one threshold; and
when this comparison meets an alerting criterion, generating an alert indicating that an earthquake has been detected.
